(19) United States
(12) Patent Application Publication
(10) Pub. No.: US 2005/0120764 A1
(43) Pub. Date: Jun. 9, 2005

(54) Frozen door opener

(76) Inventor: Russell Warner, Ontario (CA)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/728,375

(22) Filed: Dec. 3, 2003

(51) Int. Cl. A45C 11/32; A47G 29/10; A44B 15/00; E05B 63/00

(52) U.S. Cl. 70/456 R; 70/465

(57) ABSTRACT

A door opener for opening a frozen or stiff foam or rubber seal formed between a door and a door frame, which possesses first and second plate portions. The first plate portion is adapted for placement in a frame opening between the door frame and the door, and the second plate portion is adapted to be manipulated by a user, by attachment to a key chain. The first plate portion is in spaced relation to the second plate portion so as to form a substantially right angle about a central point, whereby an end of the first plate portion can be inserted for placement in the frame opening between the door frame and the door by the user, and engage a lip of the door.

### FIELD OF THE INVENTION

The present invention relates to a device for opening a stiff or frozen door which is inexpensive, reliable, and portable, and which is readily positionable in the immediate vicinity of the stiff or frozen door. More particularly, the present invention relates to a device for opening stiff or frozen vehicle doors which is simple, compact, and through use of which device great leverage can be gained to open the stiff or frozen door, without causing cosmetic damage to the exterior of the door or immediate area surrounding the vicinity where the device is inserted.

### DESCRIPTION OF THE PRIOR ART

During periods of very cold weather, it is not unusual for door linkage mechanisms, such as those found on motor vehicles, to freeze in a closed or locked position due to ice build-up in the vicinity of the mechanism, thus rendering the interior of the vehicle inaccessible to an owner or operator. Locksmiths are generally able to free the frozen linkage mechanism by thawing the surrounding ice with known chemical solvents. However, as the elongated space between a motor vehicle door and door jamb is usually quite narrow, it is often difficult to apply such solvents directly to the linkage mechanism. Also, in very cold and windy weather, such solvents are often rendered incapable of sufficiently thawing the ice so as to free the mechanism from its latched or locked position. In these extreme cases, it is usually necessary to resort to towing the vehicle to a heated garage where the linkage will thaw gradually. Such measures are both costly and inconvenient to the owner of the vehicle.

U.S. Pat. No. 4,732,562 (Palsson) describes a device for thawing frozen door locks, which is inserted into the keyhole in the frozen lock, wherein a user then blows into a tube on the device so that the warm expiration air flows through the keyhole into the lock, thus thawing the door lock, and rendering it operable.

However, while there are several prior art solutions which adequately address the issue of thawing frozen vehicle door locks, many problems and inefficiencies remain which have not yet been adequately addressed by the prior art, with respect to providing a simple and convenient device for opening vehicle door panels which are frozen or stuck to the frame of the vehicle. In situations, where a vehicle door panel is frozen or stuck, as a result of, for example, frozen condensation freezing between the vehicle door panel and the frame of the vehicle, even if the vehicle door lock is operable, the vehicle door will still not open, thus denying the user entry into the vehicle.

### SUMMARY OF THE INVENTION

The object of the present invention is to provide an improved device for opening a stiff or frozen door which is inexpensive, reliable, and portable, and which is readily positionable in the immediate vicinity of the stiff or frozen door.

It is a further object of the present invention to provide an improved device for opening stiff or frozen doors which is simple, compact, portable, and through use of which device the stiff or frozen door can be opened.

A further object of the present invention is to provide an improved device for opening stiff or frozen doors which will function effectively and efficiently without causing cosmetic damage to the exterior of the door or immediate area surrounding the vicinity where the device is inserted.

Accordingly, one aspect of the present invention provides for a device for opening a frozen or stiff seal formed between a door and a door frame, said device comprising interconnected first and second plate portions having an upper and lower surface, the first plate portion being in spaced relation to the second plate portion to form a substantially right angle about a central point, whereby the first plate portion is inserted for placement in a frame opening between the door frame and the door by a user, and the second plate portion is then pulled in a first direction by the user away from the door frame, wherein the upper surface of the first plate portion engages a lip of the door, and moves the first plate portion upwardly from the placement between the door frame and the door so as to separate and break the frozen or stiff seal formed between the door and the door frame.

A further aspect of the present invention provides for a one-piece unitary device for opening a frozen or stiff seal formed between a door and a door frame, said device comprising first and second plate portions having an upper and lower surface, wherein the first plate portion is adapted for placement in a frame opening between the door frame and the door, and the second plate portion is adapted for use by a user, the first plate portion being in spaced relation to the second plate portion to form a substantially right angle about a central point, whereby the user can maneuver the device, as a result of the angled relationship of the first and second plate portions, and insert the first plate portion for placement in a frame opening between the door frame and the door by the user, wherein the upper surface of the first plate portion engages a lip of the door and the second plate portion is then pulled in a first direction by the user away from the door frame to move the first plate portion upwardly from the placement between the door frame and the door so as to separate and break the frozen or stiff seal formed between the door and the door frame.

A still further aspect of the present invention provides a one-piece unitary device for opening a frozen or stiff seal formed between a door and a door frame, said device comprising first and second plate portions having an upper and lower surface, an end of the first plate portion being adapted for placement in a frame opening between the door frame and the door and the second plate portion being adapted for attachment to a key chain, the first plate portion being in spaced relation to the second plate portion to form a substantially right angle about a central point of from 60 degrees to 85 degrees, whereby the user can maneuver the device, as a result of the angled relationship of the first and second plate portions, and insert the end of the first plate portion for placement in the frame opening between the door frame and the door, an upper surface of the first plate portion engaging a lip of the door, and, as the key chain attached to the second plate portion is then pulled in a first direction by the user away from the door frame, the first plate portion is moved upwardly from the placement between the door frame and the door so as to contact the lip of the door, and separate and break the frozen or stiff seal formed between the door and the door frame as the user pulls the key chain further in the first direction.

A still further aspect of the present invention provides a one-piece unitary device for opening a frozen or stiff seal formed between a door and a door frame, said device comprising first and second plate portions having an upper and lower surface, an end of the first plate portion being adapted for placement in a frame opening between the door frame and the door and the second plate portion being adapted for attachment to a key chain, the first plate portion being in spaced relation to the second plate portion to form a substantially right angle about a central point of from 45 degrees to 85 degrees, whereby the user can maneuver the device, as a result of the angled relationship of the first and second plate portions, and insert the end of the first plate portion for placement in the frame opening between the door frame and the door, an upper surface of the first plate portion engaging a lip of the door, and, as the key chain attached to the second plate portion is then pulled in a first direction by the user away from the door frame, the first plate portion is moved upwardly from the placement between the door frame and the door so as to contact the lip of the door, and separate and break the frozen or stiff seal formed between the door and the door frame as the user pulls the key chain further in the first direction.

Advantageously, the present invention allows an improved device for opening stiff or frozen doors which is simple, reliable, compact, and through use of which device the stiff or frozen door can be opened. Another advantage of the present invention is that it is very portable and inexpensive, and can be inserted onto a key chain, enabling the user to have easy access to the device at all times.

A further advantage of the present invention is that, by virtue of the one-piece unitary angled design of the device, the device can be used to open stiff or frozen doors without damaging the surface finish of the door or immediate area surrounding the vicinity where the device is inserted.

### BRIEF DESCRIPTION OF THE DRAWINGS

A preferred embodiment of the present invention is described below with reference to the accompanying drawings, in which:

FIG. 1 illustrates an embodiment of a side view of the door opener of the present invention, showing an embodiment of a key chain secured therethrough;

FIG. 2 illustrates a top perspective view of the door opener of FIG. 1, with an embodiment of a key chain secured therethrough; and

FIG. 3 illustrates a top view of a car door frame, with car door securely closed, and which illustrates the car door opener of the present invention placed between the car door frame and the door, and the direction of movement the user is to pull the device to open a frozen car door, the direction of movement being shown with arrows.

### DESCRIPTION OF THE PREFERRED EMBODIMENT

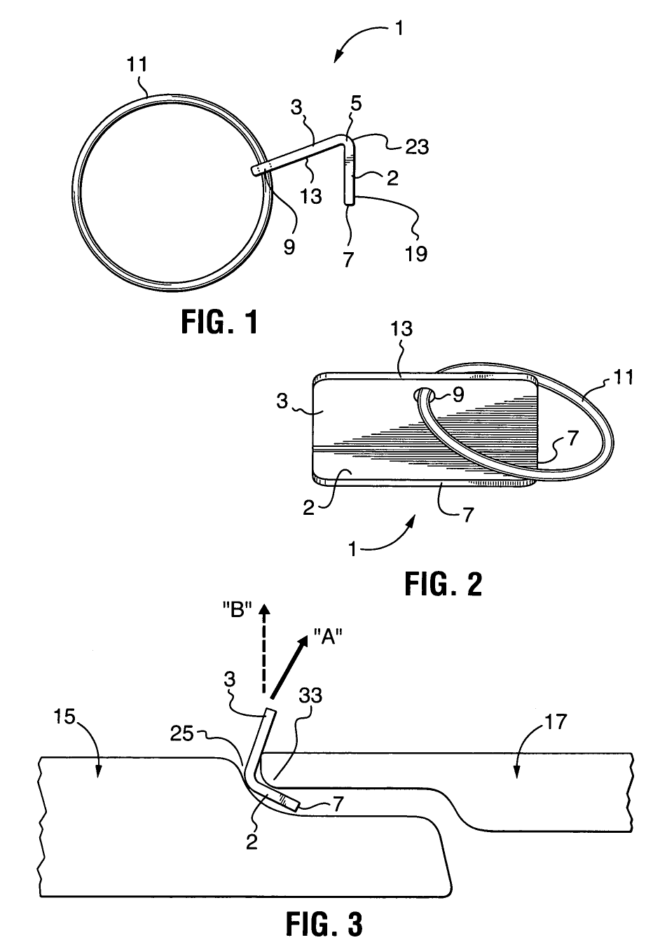

FIG. 1 illustrates a car door opener 1 of the present invention for opening a frozen or stiff seal formed between a door and a door frame, having a first plate portion 2 and a second plate portion 3. As can be seen in FIG. 1, the first plate portion 2 is in spaced relation to the second plate portion 3 to form a substantially right angle about a central point 5. Preferably, the first 2 and second plate portions 3 are disposed from 60 degrees to 85 degrees from each other about the central point 5, though it is conceivable that the first 2 and second plate portions 3 could be disposed from between 45 degrees to 85 degrees from each other, as would be apparent to a person skilled in the art.

With reference to FIG. 2, a top perspective view of the car door opener illustrated in FIG. 1 is shown, which shows the second plate portion 3 having an aperture 9 therein, wherein a ring of a key chain 11 is inserted through the aperture 9 and the car door opener 1 is secured to the key chain 11. Preferably, the aperture 9 is positioned towards an upper end 13 of the second plate portion 3. Alternatively, the device could be formed as a one piece device, such as done with injection molding, with the key ring molded or formed as part of the device. When used to open a frozen or stiff seal formed between a door and a door frame by a user, and with reference to FIG. 3, an end 7 of the first plate portion 2 is maneuvered and inserted for placement in a frame opening 25 between the door frame 15 and the door 17 by a user, whereby the second plate portion 2 can, by virtue of the angled relationship between the first plate portion 2 and the second plate portion 3, be placed to reside under a lip 33 of the door 17. Once the first plate portion 2 is in place under the lip 33 of the door 17, the second plate portion 3 (which is connected to the key chain 11) is then pulled towards, in a preferred embodiment, a first direction (as indicated by arrow A on FIG. 3) by the user away from the door frame, so that the first plate portion 2 is moved upwardly and away from its placement between the door frame 15 and the door 17 (in the course of which engaging the lip 33 of the door 17), and forcing the door 17 away from its adjacent relationship with the door frame 15 (as it lies in the “closed” position), so as to separate and break the frozen or stiff seal formed between the door 17 and the door frame 15.

Alternatively, once the first plate portion 2 is in place under the lip 33 of the door 17, the second plate portion 3 (which is connected to the key chain 11) is then pulled, in an alternate embodiment, in a second direction (as indicated by arrow B on FIG. 3) by the user away from the door frame, so that the first plate portion 2 is moved upwardly and away from its placement between the door frame 15 and the door 17 (in the course of which engaging the lip 33 of the door 17), and forcing the door 17 away from its adjacent relationship with the door frame 15. Further, the device of the present invention can be used without causing cosmetic damage to the exterior surfaces of the door 17 or door frame 15, since the first plate portion 2 moves upwardly to engage the lip 33 on the underside of the door 17, as the second plate portion 3 is pulled by the user through the key chain 11, to move the door opener of the present invention away from contact with the door frame 15.

It should be noted that the device can also “pivot” about the central point 5, to assist the user in maneuvering and inserting for placement an end 7 of the first plate portion 2 in the frame opening 25 between the door frame 15 and the door 17, whereby the door opener 1 can thus obtain a secure “grip” between the first plate portion 2 and the lip 33 of the door 17. In this manner, an outer edge 23 of the central point 5 will bias, as can be seen with reference to FIG. 3, against an upper surface of the door frame 15, and a lower surface 19 of the first plate portion 2 (as can be seen with reference to FIG. 1) will also be in close proximity to the upper surface of the door frame 15, which can be seen with reference to FIG. 3.

Preferably, the door opener 1 of the present invention is a one-piece unitary device and is made of metal, as, with such a construction, the durability of the door opener 1 is greatly enhanced. However, the door opener of the present invention could also be made of molded plastic, fiberglass or aluminum, for example. In addition, it is also conceivable that the first 2 and second plate portions 3 could be, for example, hingedly connected together about the central point 5, or other configurations known to persons skilled in the art. In the preferred embodiment however, the present invention is a one-piece unitary device, wherein the first 2 and second plate portions 3 are of a compact length, so that, when the end 7 of the first plate portion 2 is inserted for placement in a frame opening 25 between the door frame 15 and the door 17 by a user (and engage the lip 33 of the door 17), and the second plate portion 3 is pulled, preferably, in a first direction (as indicated by arrow A on FIG. 3) by the user away from the door frame 15, the compact length of the first 2 and second plate portions 3 reduces the likelihood of the first 2 or second plate portions 3 breaking or separating from each other during use. The likelihood of the first 2 or second plate portions 3 breaking or separating from each other during use is further reduced by it being, in the preferred embodiment, a one-piece unitary device made of metal. Through such design, the door opener 1 of the present invention can be used to force the door 17 away from an adjacent relationship with the door frame 15, so as to separate and break the frozen or stiff seal formed between the door 17 and the door frame 15.

If necessary, the door opener 1 can also be placed by the user in the frame opening 25 at several different locations along a total length of the frame opening 25 between the door frame 15 and the door 17, and the door opener 1 applied thereto by the user to break the frozen or stiff seal formed between the door 17 and the door frame 15, and thus allow the user the opportunity to open the door.

The present invention has been described herein with regard to preferred embodiments. However, it will be obvious to persons skilled in the art that a number of variations and modifications can be made without departing from the scope of the invention as described herein.

1. A device for opening a frozen or stiff seal formed between a door and a door frame, said device comprising interconnected first and second plate portions of substantially equal length and each having an upper and lower surface and a width which is constant along an entire length of the first and second plate portions, the first plate portion being in spaced relation to the second plate portion to form a substantially right angle about a central point of from 60 degrees to 85 degrees, whereby the first plate portion is inserted for placement in a frame opening between the door frame and the door by a user, and the second plate portion is then pushed in a first direction by the user towards an upper surface of the door frame, and, as a result of the angled relationship between the first and second plate portions, the device pivots about the central point, whereby an outer edge of the central point biases within the frame opening and moves the first plate portion into engagement with an underside of a lip of the door, allowing the user to apply moderate leverage to the device and effect the first plate portion to pivot upwardly, about the central point, from the placement between the door frame and the door and force the car door away from an adjacent relationship with the door frame so as to separate and break the frozen or stiff seal formed between the door and the door frame.

2. The device of claim 1, wherein the device is a one-piece unitary device.

3. Th device of claim 1, wherein the first plate portion is adapted for placement in a frame opening between the door frame and the door, and the second plate portion is adapted for use by the user.

4. A one-piece unitary device for opening a frozen or stiff seal formed between a door and a door frame, said device comprising first and second plate portions of substantially equal length and each having an upper and lower surface and a width which is constant along an entire length of the first and the second plate portions, wherein the first plate portion is adapted for placement in a frame opening between the door frame and the door, and the second plate portion is adapted for use by a user, the first plate portion being in spaced relation to the second plate portion to form a substantially right angle about a central point of from 60 degrees to 85 degrees, whereby the user can maneuver the device, as a result of the angled relationship of the first and second plate portions, and insert the first plate portion for placement in a frame opening between the door frame and the door by the user, wherein the upper surface of the first plate portion engages a lip of the door and the second plate portion is then pushed in a first direction by the user towards an upper surface of the door frame and, as a result of the angled relationship between the first and second plate portions, the device pivots about the central point, whereby an outer edge of the central point biases within the frame opening, allowing the user to apply moderate leverage to the device and effect the first plate portion to pivot upwardly, about the central point, from the placement between the door frame and the door and force the car door away from an adjacent relationship with the door frame, so as to separate and break the frozen or stiff seal formed between the door and the door frame.

5. The device of claim 1, wherein said second plate portion defines an aperture therein.

6. The device of claim 5, wherein a ring of a key chain is inserted through the aperture and the device is secured to a key chain.

7. The device of claim 6, wherein the aperture is positioned on an upper end of the second plate portion.

8. The device of claim 1, wherein the device is formed of metal, plastic, fiberglass or aluminum.

9-11. (canceled)

12. The device of claim 1, wherein the device is placed in the frame opening at several different locations along a length of the frame opening between the door frame and the door, and the device is applied by the user to break the frozen or stiff seal formed between the door and the door frame.

13. (canceled)

14. The device of claim 1, wherein the key ring is integrally formed as a portion of the device.

15. The device of claim 14, wherein the device is formed through injection molding.
